(19) United States
(12) Patent Application Publication
(10) Pub. No.: US 2021/0049076 A1
(43) Pub. Date: Feb. 18, 2021

(54) GEOGRAPHIC ZONE DATA RECOVERY IN GEOGRAPHICALLY DISTRIBUTED DATA STORAGE ENVIRONMENT

(71) Applicant: EMC IP Holding Company LLC, Hopkinton, MA (US)

(72) Inventors: Mikhail Danilov, Saint Petersburg (RU); Konstantin Buinov, Prague (CZ)

(21) Appl. No.: 16/538,984

(22) Filed: Aug. 13, 2019

(51) Int. Cl. G06F 11/14; G06F 3/06

(52) U.S. Cl. CPC G06F 11/1469; G06F 3/0604; G06F 3/0655; G06F 3/067

(57) ABSTRACT

The described technology is generally directed towards recovery of data segments from geographic zones (dynamic GEO recovery) by having a zone that needs the data direct the recovery process using counterpart segments. If needed data, such as to respond to a client request, is owned by another zone but is lost or corrupt and therefore unavailable from that owning zone, the owning zone instructs the requesting zone to perform recovery. The zone performs recovery by obtaining the counterpart segments, combining (XOR-ing) the counterpart recovery segments into the needed segment, and returns the data to the client. If the zone performing recovery owns one of the counterpart segments, only one of the two counterpart segments needs to be communicated over the inter-zone network, facilitating more efficient, less resource-demanding GEO recovery.

### TECHNICAL FIELD

The subject application relates generally to data storage, and, for example, to a technology that facilitates recovering lost or corrupt data, including in a geographically distributed environment, and related embodiments.

### BACKGROUND

Contemporary data storage systems, such as Dell EMC®'s ECS (formerly Elastic Cloud Storage) service, store data in a way that ensures data protection while retaining storage efficiency. For additional protection of user data and metadata, ECS supports geographically distributed setups of multiple zones (geographically distributed node clusters), with the data and metadata of one zone distributed and replicated to two or more zones by asynchronous replication.

When there are three or more geographic zones, an eXclusive OR (XOR) technique can be used to minimize capacity overhead associated with such additional data protection. Instead of storing multiple blocks (such as a chunk) of identically replicated data per zone, one zone can store one block of data, another zone can store a different block of data, and yet another zone can store a third block of data that is a bitwise XOR of the two different blocks. For example, consider that some block A of data is owned by Zone 1; Zone 1 can store block A, Zone 2 can store a (different) block B, and zone X can store block X, which is block A XOR'ed with block B. Then if block A is ever lost or corrupt, block A can be restored via an XOR of block X and block B; similarly if bock B is ever lost or corrupt, block B can be restored via an XOR of block X and block A.

To be practical in a large data storage system, such data blocks (e.g., chunks) are relatively large, whereby recovery of a complete data block involving distributed geographic zones can take a relatively long amount of time. Thus, if some amount of data (such as an object) is needed and cannot be returned from a lost or corrupt chunk from its owning zone, rather than wait for the restoration to complete, the owning zone requests XOR recovery of a segment of data identified by an offset and size. However, the zone that owns the data is responsible for the recovery of the segment, which can be inefficient in many scenarios.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of part of a data storage system including nodes and geographic zones, in which geographic recovery of data can be performed, in accordance with various aspects and implementations of the subject disclosure

FIGS. 2-4 are example block diagram/data flow diagram representations related to data recovery by a non-owning zone in a distributed zone environment in various scenarios, in accordance with various aspects and implementations of the subject disclosure.

FIG. 5 is an example block diagram/data flow diagram representations related to data recovery by an owning zone in a distributed zone environment, in accordance with various aspects and implementations of the subject disclosure.

FIG. 6 is an example flow diagram showing example operations related to having an owning node instruct a requesting zone to implement zone-based data recovery on its own, in accordance with various aspects and implementations of the subject disclosure.

FIG. 7 is an example flow diagram showing example operations of a zone related to receiving an instruction to implement zone-based data recovery, in accordance with various aspects and implementations of the subject disclosure.

FIG. 8 is an example flow diagram showing example operations of a zone related to receiving a client request for data, including when the data is owned but not returnable, in accordance with various aspects and implementations of the subject disclosure.

FIG. 9 is an example flow diagram showing example operations related to performing data recovery in a geographic zone when instructed by a zone that owns the data that the data cannot be returned, in accordance with various aspects and implementations of the subject disclosure.

FIG. 10 is an example flow diagram showing example operations related to instructing a zone that is requesting data to recover the data on its own, when the data cannot be returned, in accordance with various aspects and implementations of the subject disclosure.

FIG. 11 is an example flow diagram showing example operations related to performing data recovery in a geographic zone, by obtaining the recovery data parts, when instructed by a zone that owns the data that the data cannot be returned, in accordance with various aspects and implementations of the subject disclosure.

FIG. 12 is a block diagram representing an example computing environment into which aspects of the subject matter described herein may be incorporated.

FIG. 13 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards reducing inter-zone network traffic when data needs to be recovered. In one aspect, when a remote zone receives a client request for lost or corrupt data that is owned by another, owning zone, instead of having the owning zone recover and return the data to the remote zone, the owning zone instructs the remote zone to recover and return the data to the requesting client. In one scenario, for example, this can reduce the number of times that the data segment/its recovery segment is communicated across inter-zone boundaries from three to one.

It should be understood that any of the examples herein are non-limiting. For instance, some of the examples are based on ECS data storage technology; however virtually any storage system may benefit from the technology described herein. As a more particularly example, the term “chunk” can be used as an example of a unit of data storage, however any data block can be used in other storage systems. Similarly, a “segment” identified by an “offset” and “size” is used to indicate part of a data chunk/block, although it is understood that other terms that can identify such a sub-unit of storage can be used. Thus, any of the embodiments, aspects, concepts, structures, functionalities or examples described herein are non-limiting, and the technology may be used in various ways that provide benefits and advantages in computing and data storage in general.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

In ECS, disk space is partitioned into a set of blocks of fixed size called chunks, which in one or more implementations are 128 megabytes in size. The various types of data, including user data and various types of metadata, are stored in chunks. There are different types of chunks, one type per capacity user. In particular, user data is stored in repository chunks, and chunks can be shared. For instance, one chunk may (and in typical cases does) contain segments of multiple user objects.

As set forth herein, geographic zones can be used to replicate data, including user chunks, for additional data protection. The various user data chunks are distributed among the zones, with one zone (a node in the zone cluster) responsible for owning a given chunk. Because replication takes time (and because in environments having three or more zones the data is not directly available at another zone), a client request to one zone for data that is in a chunk owned by another zone is obtained by having the other zone request and receive the data from the owning zone, and then once received return the data to the requesting client.

However, when the requested data is not available from the zone that owns the chunk, the requested data needs to be recovered. As set forth herein, recovery of a complete chunk (e.g., 128 MB) can take time, so the needed segment is recovered separately. For data storage environments having three or more zones, XOR can be used; for Zone 1 (which owns Chunk A) and Zone 2 (which owns Chunk B), both zones can replicate their respective chunks A and B to Zone 3. Zone 3 does not store chunk copies for Chunk A and Chunk B but instead only one Chunk X is stored by Zone 3, comprising the result of XOR (eXclusive OR) for Chunk A content and Chunk B content, that is, Chunk X=XOR(Chunk A, Chunk B).

When a chunk with user data, e.g., Chunk A or Chunk B, is unavailable, the corresponding XOR chunk can be used to restore its content via GEO recovery. GEO recovery can be represented as:

Chunk A=XOR(Chunk X,Chunk B), and

Chunk B=XOR(Chunk X,Chunk A).

In such a setup, Chunk A contains an object segment, with the segment's content represented as Chunk A(offset, size). Then, if Chunk A is lost/corrupt, the object segment can be quickly recovered using (relatively small) parts of Chunk X and Chunk B, by:

Chunk A(offset,size)=XOR(Chunk X(offset,size),Chunk B(offset,size)).

Given the above examples, consider that a client requests an object from Zone 2 in which the objects corresponds to the Chunk A(offset, size) segment owned by Zone 1. Zone 2, which contains information that indicates that Zone 1 owns chunk A, requests the data segment (abbreviated to A(o,s)) from Zone 1. In this example, consider that Chunk A is lost or corrupt; when this occurs, Zone 1 requests Zone 3 to recover A(o,s) using its XOR-ed Chunk X. Zone 3 recognizes that B(o,s)) is needed to do this, and thus requests and receives B(o,s)) from zone 2; (note that this is a first time the segment-related data of size s, of counterpart segment B(o,s) is communicated from one zone to another).

Zone 3 then uses its Chunk X to XOR X(o,s) with B(o,s), and thereby return recovered chunk A(0,s) to Zone 1; (note that this is a second time the segment-related data of size s, of recovered segment A(o,s) is communicated from one zone to another). Zone 1 then returns recovered segment A(o,s) to Zone 2, (note that this is a third time the segment-related data of size s, of recovered segment A(o,s) is communicated from one zone to another). Zone 2 in turn responds to the client with A(o,s) to complete the client request.

As is understood, there are various cycles of data requests and data segments transmissions. In particular, data segments of size s are transmitted over inter-zone network three times in the above scenario. Described herein is a technology that facilitates more efficient geographic data recovery, by having the zone that receives a data read request from a client perform the data recovery, which as will be understood, reduces the number of times that the data segments of size s need to be transmitted across zones.

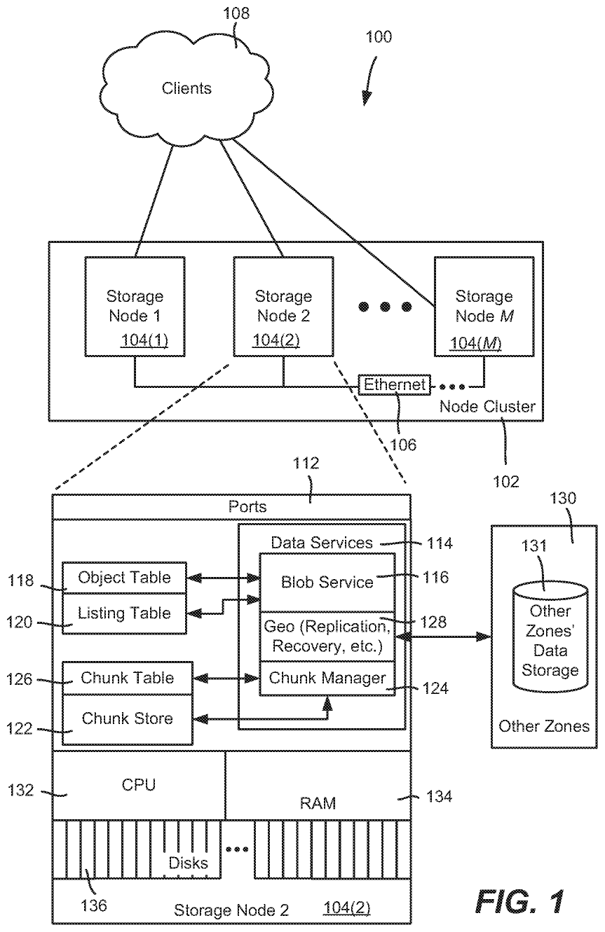

FIG. 1 shows part of a data storage system 100 (such as ECS) comprising a node cluster 102 of storage nodes 104(1)-104(M), in which each node is typically a server configured primarily to serve objects in response to client requests. The nodes 104(1)-104(M) are coupled to each other via a suitable data communications link comprising interfaces and protocols, such as represented in FIG. 1 by Ethernet block 106.

Clients 108 make data system-related requests to the cluster 102, which in general is configured as one large object namespace; there may be on the order of billions of objects maintained in a cluster, for example. To this end, a node such as the node 104(2) (shown enlarged in FIG. 1 as well) generally comprises ports 112 by which clients connect to the cloud storage system. Example ports are provided for requests via various protocols, including but not limited to SMB (server message block), FTP (file transfer protocol), HTTP/HTTPS (hypertext transfer protocol) and NFS (Network File System); further, SSH (secure shell) allows administration-related requests, for example.

Each node, such as the node 104(2), includes an instance of a data storage system and data services 114; (note however that at least some data service components can be per-cluster, rather than per-node). For example, ECS runs a set of storage services, which together implement storage logic. Services can maintain directory tables for keeping their metadata, which can be implemented as search trees. A blob service 116 maintains an object table 118 (e.g., in various partitions among nodes, including geographically separated zones) that keeps track of objects in the data storage system and generally stores their metadata, including an object's data location information, e.g., within a chunk. The blob service 116 also maintains a listing table 120, although it is alternatively feasible to have such a listing table maintained by another service.

FIG. 1 further represents some additional concepts, in that the user data repository of chunks is maintained in a chunk store 122, managed by another storage service referred to as a chunk manager 124. A chunk table 126 maintains metadata about chunks, e.g., as managed by the chunk manager 124. Note that directory tables and other data can also be maintained in data chunks.

In one or more implementations, the data services 114 can also include geographic-related services (block 128), such as replication and (as described herein) geo-recovery related communications to and from remote zones 130 and their data storage 131. As is understood, sending data between a local zone and a remote zone is relatively inefficient, and are thus reduced to the extent possible via the technology described herein.

In FIG. 1, a CPU 132 and RAM 134 are shown for completeness; note that the RAM 132 may comprise at least some non-volatile RAM. The node 104(2) further includes storage devices such as disks 136, comprising hard disk drives and/or solid-state drives, or any other suitable type of storage resource. As can be readily appreciated, components of the data storage system including those described herein can be at various times in any storage device or devices, such as in the RAM 134, in the disks 136, or in a combination of both, for example.

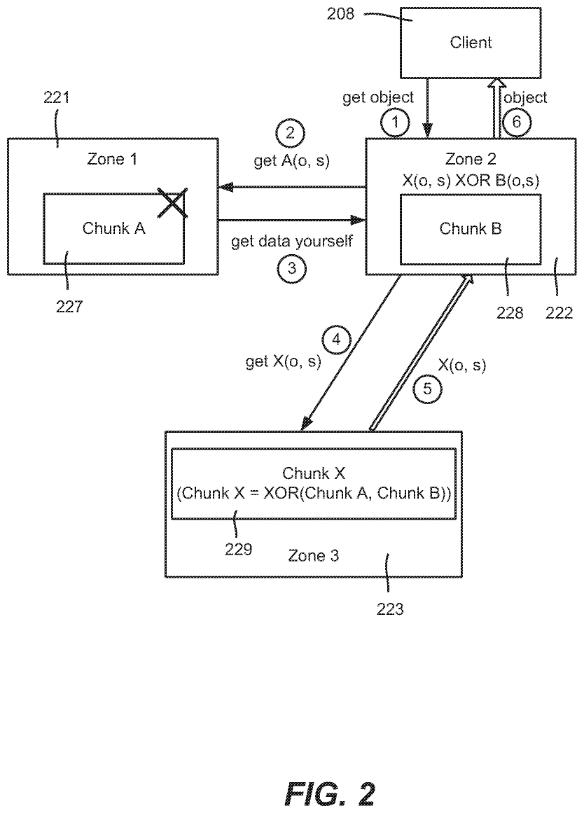

As represented in FIG. 2, in an example implementation similar to the above example(s), a read request for an object's data is received from a client 208 (the arrow labeled one (1)) at a Zone B 222. As before, in this example Zone 1 221 owns Chunk A 227, Zone 2 222 owns Chunk B 228, and Zone 3 223 own chunk X 229 based on the XOR-ing of replicated copies of respective chunk A 227 and chunk B 228 to Zone 3 223.

When the read request is received and processed, Zone 2 222 requests the relevant segment and chunk associated with the requested object, and at arrow two (2) sends a request for the segment “get A(0,s)” to the chunk A's owner, Zone 1 222. The Zone A 221 detects that the Chunk A's data cannot be returned (Chunk A 227 is lost/corrupt, as indicated by the large crossed lines in the upper right corner of the block representing chunk A 229), and responds with an indication that the data cannot be returned, such as a communication (arrow three (3)) instructing Zone B 222 to get the data itself. Such a “get-data-yourself” instruction can be an errorcode or the like understood by the various zones.

Chunk B receives the “get data yourself” instruction, accesses its information indicating that Zone 3 223 contains the needed XOR recovery part of the segment in chunk X, and requests X(o,s) from the Zone 3 223, as represented by the labeled arrow four (4). Zone 3 responds with the counterpart recovery segment X(o,s) at arrow five (5). Note that in FIG. 2, this is the first (and only) time that data of size s is communicated across zones.

Note that depending on storage system implementation specifics, the “get-data-yourself” instruction can be accompanied by further instructions on how the recovery can be performed. For example, the Zone 1 can instruct the requesting zone as to which other zones contain the recovery parts, in this example Zone 2 and Zone 3.

Once Zone 2 222 receives segment X(o,s) from the zone 3 223, the requested segment data is recovered by XOR-ing segment X(o,s) with Chunk B's counterpart segment B(o,s). The requested object is thus returned to the client 208 as represented in FIG. 2 by the labeled arrow six (6).

As can be seen, the initial scenario for segment A(o,s) is the same as previously handled, but the zones act differently. Instead of Zone 1 driving data recovery when Zone 1 detects corruption/loss of its Chunk A, Zone 1 instructs Zone 2 to drive the recovery. From this instruction, Zone 2 realizes that the data is unreturnable from Zone 1, whereby Zone 2 takes charge of on-the-fly GEO recovery of the data. Note that Zone 2 already has the segment B(o,s) in Chunk B 228, and that segment X(o,s) is needed for the recovery. Zone 2 reads X(o,s) from Zone 3, XOR-s this segment with local segment B(o,s), and sends the result, which is A(o,s) and the object data at the same time, to the data client. Note that any of the segment-related information can be cached for some appropriate time, so that for example if the Zone 3 receives another request corresponding to segment A(o,s), no similar GEO recovery is needed; (note that such caching is feasible in other scenarios, such as if Zone 1 was able to return the segment A(o,s)).

To summarize, the GEO recovery path that is driven by Zone 2 is much shorter than the one described above in which the owning zone drove the recovery. In particular, in the example implementation of FIG. 2, only one data segment of size s is transmitted over the inter-zone network, instead of three data segments.

Note that Zone 1 221 may also initiate full GEO recovery of complete Chunk A in conjunction with replying with the “get-data-yourself” instruction to Zone 2. Such full GEO recovery of Chunk A typically finishes long after the data read request is served.

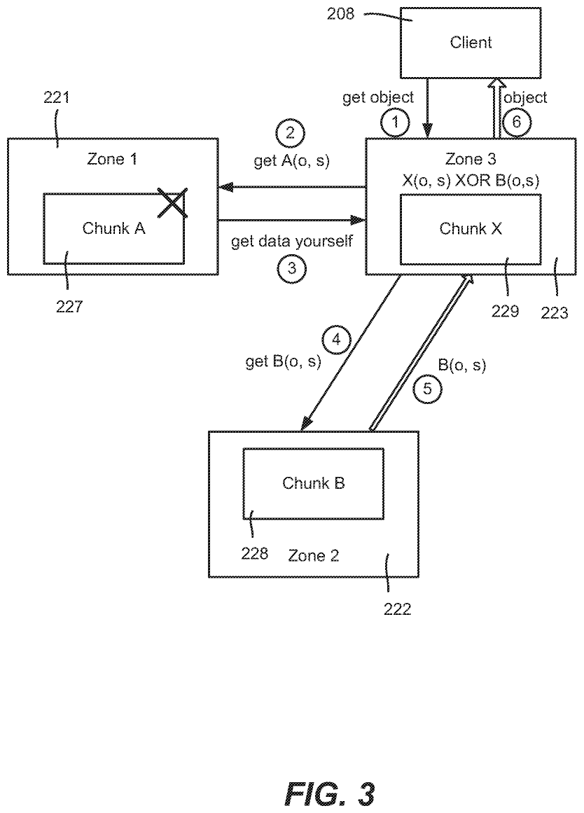

The example shown in FIG. 3 is similar to FIG. 2, except that in FIG. 3, Zone 3 223 receives the client request for the object. Thus, when Zone 3 223 receives the “get data yourself” instruction from chunk A, Zone 3 obtains segment B(o,s) from Zone 2, performs the XOR with its own segment part from Chunk X 229 to obtain A(o,s) and returns the corresponding object data to the requesting client.

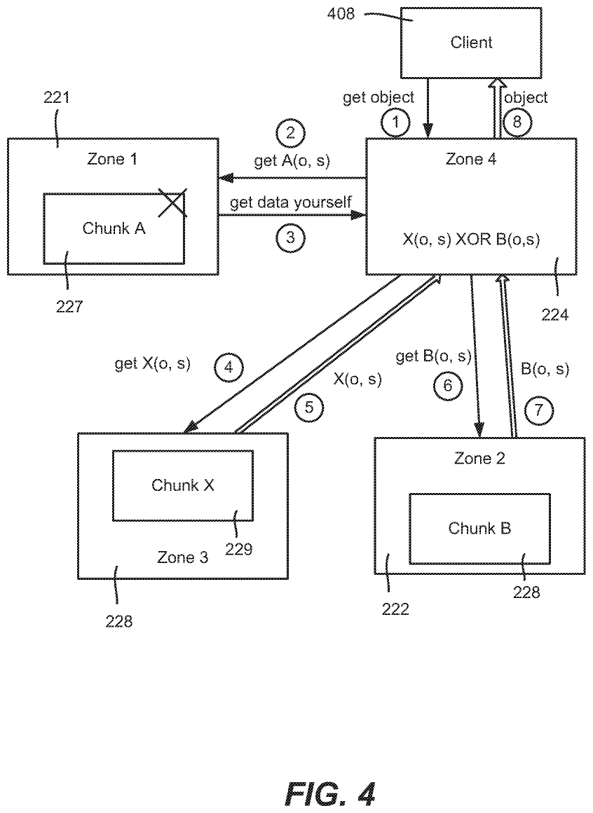

FIG. 4 shows a four zone scenario, in which a zone 4 224 that owns no recovery part of the segment receives the request for the object from some client 408. As can be seen by following the labeled arrows, by having Zone 4 224 drive the recovery via the “get-data-yourself” instruction at arrow (3), only two segments of size s need to be communicated across zones, instead of three such segments. That is, inter-zone traffic is reduced because there is no need for Zone 1 221 to get the recovered data segment A(o,s) to Zone 4 224, because Zone D 224 gets the segment parts needed to perform the XOR recovery.

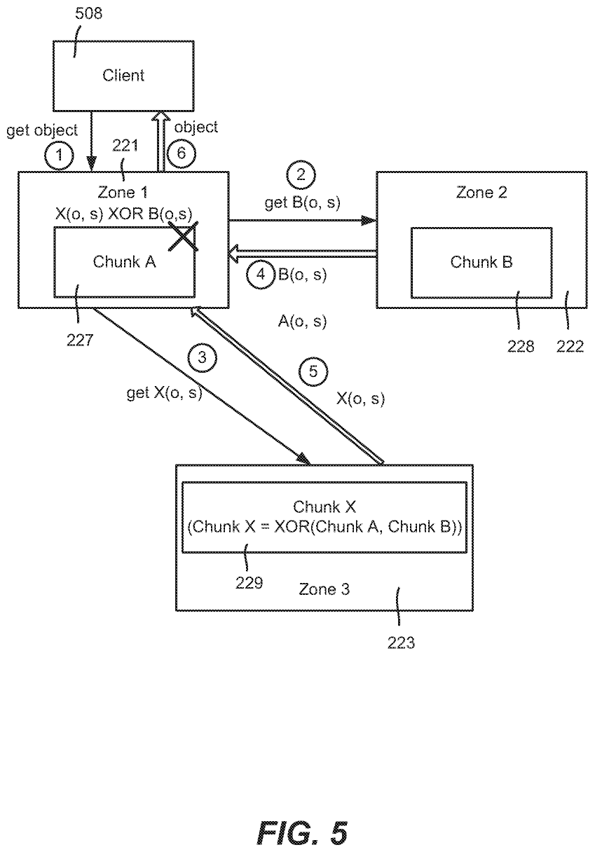

FIG. 5 shows a modified scenario in which the Zone that owns the chunk for a requested segment receives the request for the object, e.g., Zone 1 221 receives an object request for data corresponding to segment A(o,s), such as from another client 508. In this example, Zone A drives the recovery, but instead of having Zone 3 obtain chunk segment B(o,s), chunk A requests B(o,s) from Zone 2 222 (arrows 2 and 4) and X(o,s) from Zone 3 223 (arrow 3 and 5). This does not particularly reduce inter-zone communications, but allows for generally parallel requesting of the needed recovery data parts, which can be more efficient.

Whether to have Zone X be responsible for the recovery (and return recovered segment A(o,s) as in prior solutions) or to have Zone A be responsible for GEO recovery as in FIG. 5 can be dependent on other factors. Consider for example that Zone 1 is geographically between Zone 2 and Zone 3; it can be faster for Zone 1 to receive segment B(o,s) from Zone 2 while receiving segment X(o,s) from Zone 3 instead of waiting for Zone 3 to obtain B(o,s) from Zone 2. If instead Zone 3 is geographically between Zone 1 and Zone 3; it may be faster for Zone 3 to receive segment B(o,s) from Zone 2. Other factors, such as the speeds of communications links, can be considered. Still other factors such as relative zone workloads can be considered, e.g., a zone that is heavily busy such as during a busy workday can offload recovery to one of the other zones, such as one where it is nighttime and handling far less work.

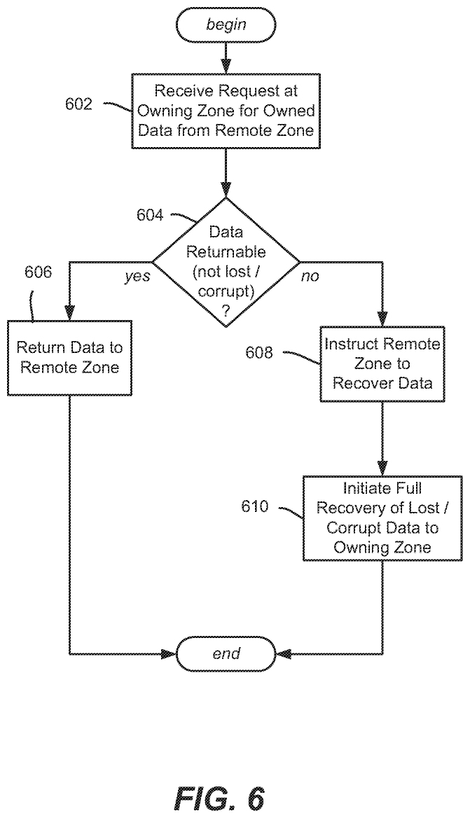

FIG. 6 shows example operations related to the “get data yourself” instruction, beginning at operation 602 where a request for owned data is received from a remote zone. If the data is returnable as evaluated at operation 604, then the requested data is returned at operation 606.

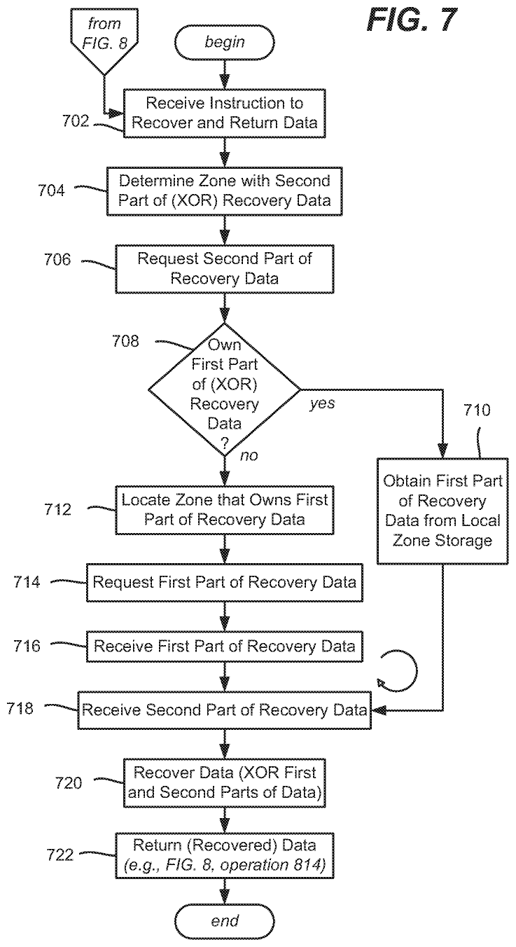

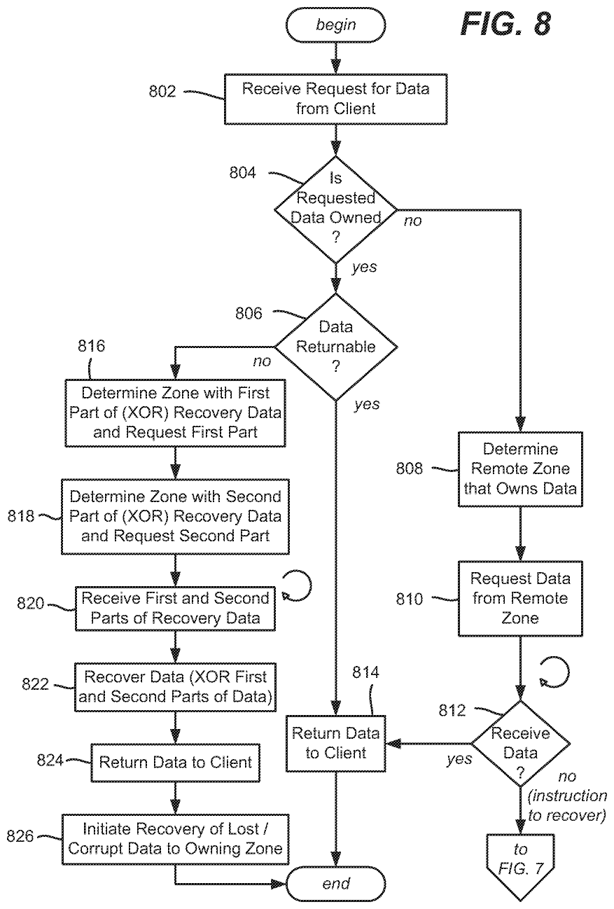

In FIG. 6, if at operation 604 the data is not returnable (as in FIGS. 2-5), e.g., is lost or corrupt, operation 608 instructs the requesting remote zone to perform the GEO data recovery operation as described herein. FIGS. 7 and 8 are directed towards operations of the other zone that receives the instruction.

Operation 610 represents the owning node initiating complete recovery of the chunk. Note that operation 610 is optional at this time, as it can be performed in a separate process/set of operations as in existing systems. It is also feasible that full recovery was previously initiated (but not yet completed) as a result of a prior request for some segment data in that chunk, e.g., A(o's′) (which could be the same segment A(o,s)).

FIG. 7 shows example operations of a zone, which in response to a request for data from an owning zone, receives the instruction to recover and return the data on its own. Operation 704 represents determining the zone that has the second part of the recovery data, that is, the XOR part from its perspective, which the zone requests at operation 706.

Operation 708 evaluates whether the zone that is driving recovery has the first part of the recovery data (as in FIG. 2), or another zone has this part (as in FIG. 4). If the zone owns the first part, operation 710 obtains this data, and branches ahead to operation 718 to await the receiving of the second part.

Otherwise, operation 714 is performed to request the first part, which is received (after some delay) at operation 716. When both parts are received, whether because of ownership at operation 710 or via the request at operation 714, operation 720 recovers (XOR-s) the data parts. Operation 722 represents returning the recovered data to the requesting entity, e.g., the client, or possibly another zone.

FIG. 8 shows operations that occur when a zone receives a request from a client to return an object. If the requested data is not owned as evaluated by operation 804, then the remote zone that owns the needed data is determined (operation 808) and a request for the data is made from the remote zone (operation 810). If the data is received as evaluated at operation 812, the data is returned to the client at operation 814, and the process ends. If instead the (“get data yourself”) instruction to recover the data is received, the operations of FIG. 7 can be performed, as described herein.

Returning to operation 804, if the requested data is owned, operation 806 evaluates whether the data is returnable, and if so, the data is returned to the client via operation 814. If the data is owned but not returnable (as in the example of FIG. 5), operations 816 and 818 determine the zones that own the recovery data parts, and request the parts from those zones.

When the first and second parts of the data are received as represented by operation 820, operation 822 recovers (XOR-s) the data parts, and operation 824 returns the data to the client. Operation 826 optionally initiates full recovery of the data chunk (if not already initiated, for example).

As set forth above, instead of taking the no branch of operation 806 (as in the example of FIG. 5), it is feasible to have another zone, such as the zone that owns the XOR chunk, drive the recovery operation (e.g., instruct that zone to recover and return the segment) according to existing solutions. To reiterate, offloading segment recovery can be dependent on other factors, such as relative locations of the zones, speed of communication links between zones, relative zone workloads, and so on.

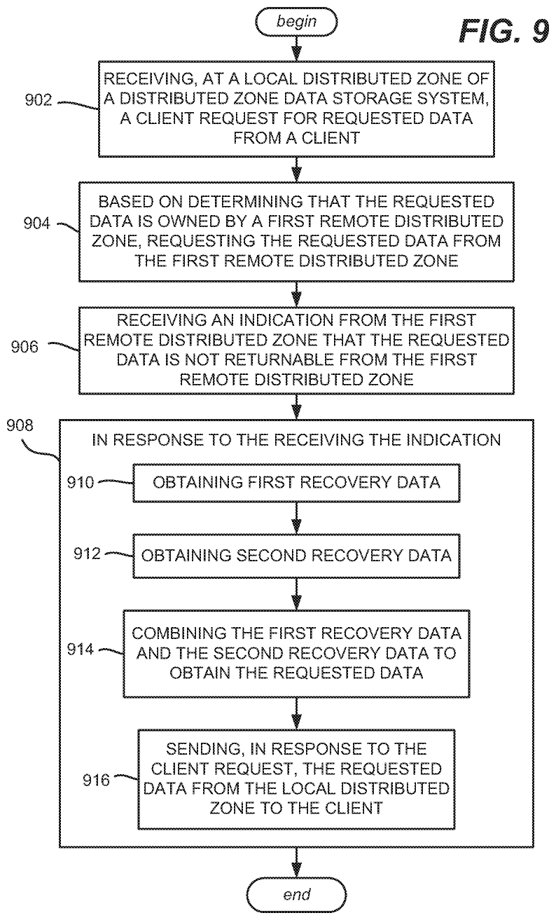

One or more aspects can be embodied in a system, such as represented in FIG. 9, and for example can comprise a memory that stores computer executable components and/or operations, and a processor that executes computer executable components and/or operations stored in the memory. Example operations can comprise operation 902, which represents receiving, at a local distributed zone of a data storage system of distributed zones, a client request for requested data from a client. Operation 904 represents, based on determining that the requested data is owned by a first remote distributed zone, requesting the requested data from the first remote distributed zone. Operation 906 represents receiving an indication from the first remote distributed zone that the requested data is not returnable from the first remote distributed zone. Operation 908 represents, in response to the receiving the indication, operation 910, which represents obtaining first recovery data, operation 910, which represents obtaining second recovery data and operation 912, which represents combining the first recovery data and the second recovery data to obtain the requested data. Operation 916 represents sending, in response to the client request, the requested data from the local distributed zone to the client.

Obtaining the first recovery data can comprise accessing a storage device of the local distributed zone; obtaining the second recovery data can comprise requesting the second recovery data from a second remote distributed zone and receiving the second recovery data from a second remote distributed zone.

Further operations can comprise receiving a recovery request from the first remote distributed zone to recover a copy of a lost or corrupt data structure owned by the first remote distributed zone that stores the requested data.

Obtaining the second recovery data can comprise requesting the second recovery data from a second remote distributed zone and receiving the second recovery data from the second remote distributed zone; obtaining the first recovery data can comprise requesting the first recovery data from a third remote distributed zone and receiving the first recovery data from the third remote distributed zone.

Combining the first recovery data and the second recovery data can comprise performing a bitwise logical XOR operation of the first recovery data and the second recovery data to obtain the requested data. The client request for the requested data can correspond to a data segment in a chunk that stores the requested data.

Requesting the requested data from the first remote distributed zone can comprise identifying the chunk, and an offset value and a size value representing the data segment.

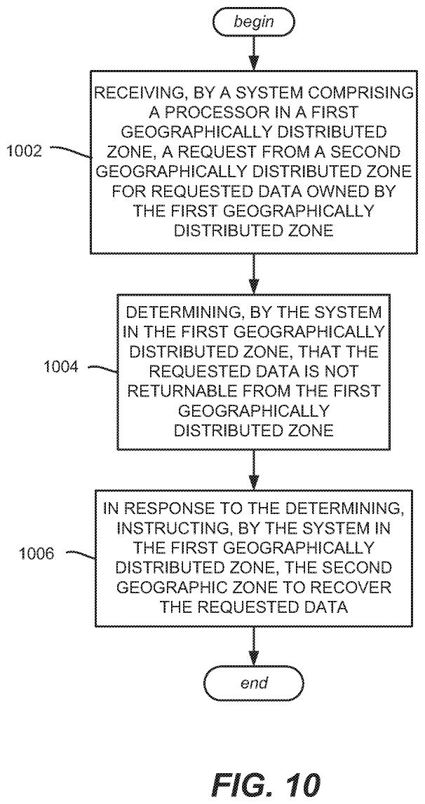

The chunk can be a first chunk, the first recovery data can correspond to a first counterpart data segment in a second chunk, and the second recovery data can correspond to a second counterpart data segment in a third chunk in which the third chunk comprises a bitwise XOR combination of the first chunk and the second chunk. One or more example aspects, such as corresponding to operations of a method, are represented in FIG. 10. Operation 1002 represents receiving, by a system comprising a processor in a first geographically distributed zone, a request from a second geographically distributed zone for requested data owned by the first geographically distributed zone. Operation 1004 represents determining, by the system in the first geographically distributed zone, that the requested data is not returnable from the first geographically distributed zone. Operation 1006 represents, in response to the determining, instructing, by the system in the first geographically distributed zone, the second geographic zone to recover the requested data.

The request can be a first request, the requested data can be first requested data, and aspects can comprise receiving, by the system in the first geographically distributed zone, a second request from a client requester for second requested data owned by the first geographically distributed zone, determining, by the system in the first geographically distributed zone, that the second requested data is not returnable from the first geographically distributed zone, and in response to the determining, instructing, by the system in the first geographically distributed zone, the second geographic zone to provide a first recovery part of the requested data, instructing, by the system in the first geographically distributed zone, a third geographic zone to provide a second recovery part of the requested data, receiving, by the system in the first geographically distributed zone, the first recovery part, receiving, by the system in the first geographically distributed zone, the second recovery part, recovering, by the system in the first geographically distributed zone, the second requested data by combining the first recovery part and the second recovery part, and returning, by the system in the first geographically distributed zone, the second requested data to the client requester in response to the second request.

Recovering the second requested data by combining the first recovery part and the second recovery part can comprise performing an XOR operation. The requested data can be part of a corrupt data storage chunk owned by the first geographically distributed zone, and aspects can comprise initiating, by the system in the first geographically distributed zone, recovery of a non-corrupt replacement copy of the corrupt data storage chunk. The requested data can be part of a lost data storage chunk owned by the first geographically distributed zone, and aspects can comprise, initiating, by the system in the first geographically distributed zone, recovery of a replacement copy of the lost data storage chunk.

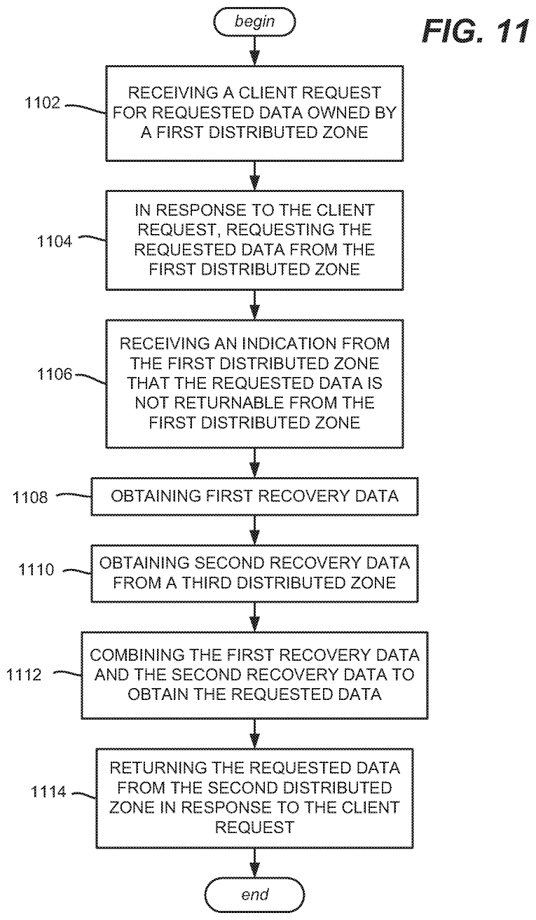

FIG. 11 summarizes various example operations, e.g., corresponding to a machine-readable storage medium, comprising executable instructions that, when executed by a processor of a system in a second distributed zone of a data storage system of geographic zones, facilitate performance of operations. Operation 1102 represents receiving a client request for requested data owned by a first distributed zone. Operation 1104 represents, in response to the client request, requesting the requested data from the first distributed zone. Operation 1106 represents receiving an indication from the first distributed zone that the requested data is not returnable from the first distributed zone. Operation 1108 represents obtaining first recovery data. Operation 1110 represents obtaining second recovery data from a third distributed zone. Operation 1112 represents combining the first recovery data and the second recovery data to obtain the requested data. Operation 1114 represents returning the requested data from the second distributed zone in response to the client request

Obtaining the first recovery data can comprise accessing a storage device of the second distributed zone. Obtaining the first recovery data can comprise requesting and receiving the first recovery data from a fourth distributed zone.

Combining the first recovery data and the second recovery data can comprise performing a bitwise XOR operation of the first recovery data and the second recovery data to obtain the requested data.

Receiving the client request can comprise receiving a request for an object that corresponds to a data segment in a data chunk owned by the first distributed zone.

The chunk can be a first chunk, obtaining the first recovery data can comprise accessing a first counterpart data segment maintained in a second chunk owned by the second distributed zone, and obtaining the second recovery data from the third distributed zone can comprise requesting a second counterpart data segment maintained in a third chunk owned by the third distributed zone.

The chunk can be a first chunk, obtaining the first recovery data can comprise requesting a first counterpart data segment maintained in a second chunk owned by a fourth distributed zone, and obtaining the second recovery data from the third distributed zone can comprise requesting a second counterpart data segment maintained in a third chunk owned by the third distributed zone.

As can be seen, described herein is technology for more efficient GEO recovery by using less resources/less inter-zone data traffic. By having a zone that needs data owned by, but unavailable from a remote zone, perform the GEO recovery, the amount of data segments needed to be transmitted over inter-zone network for recovery can be reduced, e.g., from three to one if the requesting zone owns one of the counterpart recovery segments, or from three to two if the requesting zone needs to request both counterpart recovery segments.

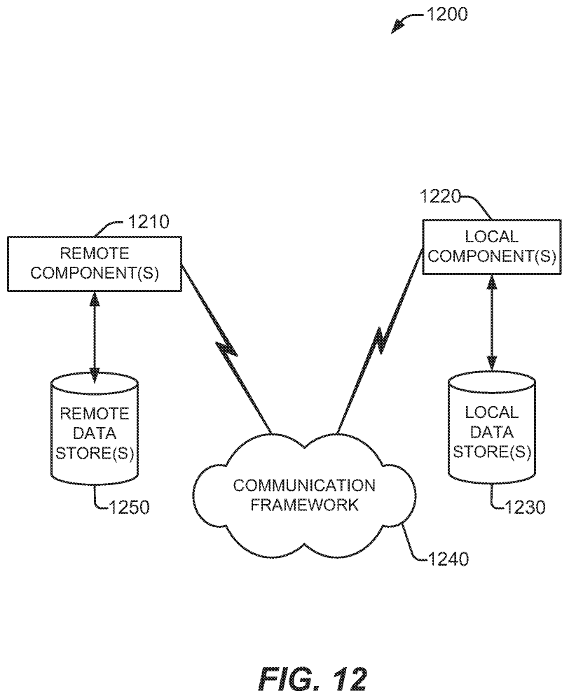

FIG. 12 is a schematic block diagram of a computing environment 1200 with which the disclosed subject matter can interact. The system 1200 comprises one or more remote component(s) 1210. The remote component(s) 1210 can be hardware and/or software (e.g., threads, processes, computing devices). In some embodiments, remote component(s) 1210 can be a distributed computer system, connected to a local automatic scaling component and/or programs that use the resources of a distributed computer system, via communication framework 1240. Communication framework 1240 can comprise wired network devices, wireless network devices, mobile devices, wearable devices, radio access network devices, gateway devices, femtocell devices, servers, etc.

The system 1200 also comprises one or more local component(s) 1220. The local component(s) 1220 can be hardware and/or software (e.g., threads, processes, computing devices). In some embodiments, local component(s) 1220 can comprise an automatic scaling component and/or programs that communicate/use the remote resources 1210 and 1220, etc., connected to a remotely located distributed computing system via communication framework 1240.

One possible communication between a remote component(s) 1210 and a local component(s) 1220 can be in the form of a data packet adapted to be transmitted between two or more computer processes. Another possible communication between a remote component(s) 1210 and a local component(s) 1220 can be in the form of circuit-switched data adapted to be transmitted between two or more computer processes in radio time slots. The system 1200 comprises a communication framework 1240 that can be employed to facilitate communications between the remote component(s) 1210 and the local component(s) 1220, and can comprise an air interface, e.g., Uu interface of a UMTS network, via a long-term evolution (LTE) network, etc. Remote component(s) 1210 can be operably connected to one or more remote data store(s) 1250, such as a hard drive, solid state drive, SIM card, device memory, etc., that can be employed to store information on the remote component(s) 1210 side of communication framework 1240. Similarly, local component(s) 1220 can be operably connected to one or more local data store(s) 1230, that can be employed to store information on the local component(s) 1220 side of communication framework 1240.

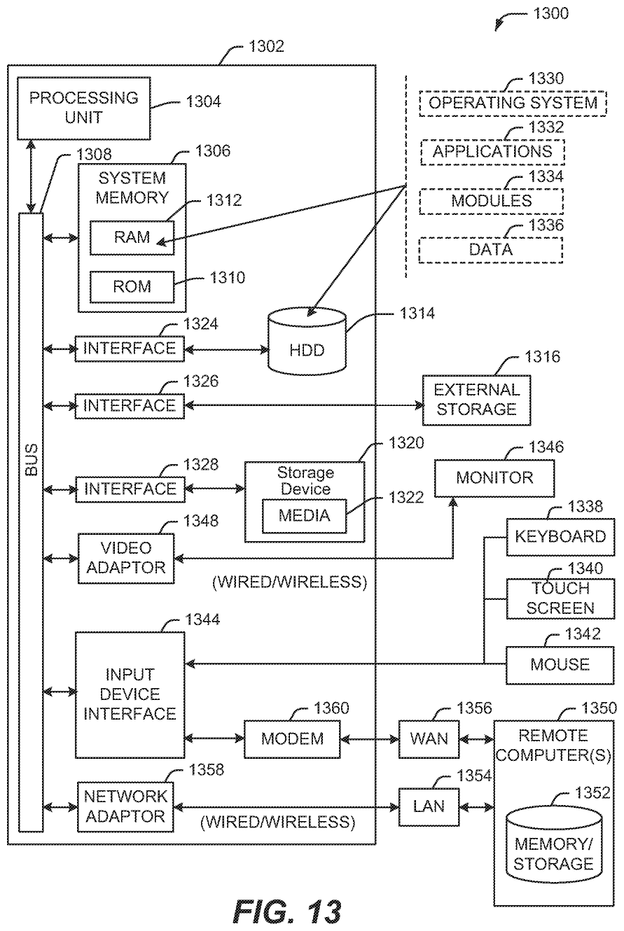

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), and can include one or more external storage devices 1316 (e.g., a magnetic floppy disk drive (FDD) 1316, a memory stick or flash drive reader, a memory card reader, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314.

Other internal or external storage can include at least one other storage device 1320 with storage media 1322 (e.g., a solid state storage device, a nonvolatile memory device, and/or an optical disk drive that can read or write from removable media such as a CD-ROM disc, a DVD, a BD, etc.). The external storage 1316 can be facilitated by a network virtual machine. The HDD 1314, external storage device(s) 1316 and storage device (e.g., drive) 1320 can be connected to the system bus 1308 by an HDD interface 1324, an external storage interface 1326 and a drive interface 1328, respectively.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A system, comprising:
a processor, and
a memory that stores executable instructions that, when executed by the processor, facilitate performance of operations, the operations comprising:
receiving, at a local distributed zone of a distributed zone data storage system, a client request for requested data from a client;
based on determining that the requested data is owned by a first remote distributed zone, requesting the requested data from the first remote distributed zone;
receiving an indication from the first remote distributed zone that the requested data is not returnable from the first remote distributed zone; and
in response to the receiving the indication,
obtaining first recovery data,
obtaining second recovery data,
combining the first recovery data and the second recovery data to obtain the requested data, and
sending, in response to the client request, the requested data from the local distributed zone to the client.

2. The system of claim 1, wherein the obtaining the first recovery data comprises accessing a storage device of the local distributed zone, and wherein the obtaining the second recovery data comprises requesting the second recovery data from a second remote distributed zone and receiving the second recovery data from a second remote distributed zone.

3. The system of claim 2, wherein the operations further comprise receiving a recovery request from the first remote distributed zone to recover a copy of a lost or corrupt data structure owned by the first remote distributed zone that stores the requested data.

4. The system of claim 1, wherein the obtaining the second recovery data comprises requesting the second recovery data from a second remote distributed zone and receiving the second recovery data from the second remote distributed zone, and wherein the obtaining the first recovery data comprises requesting the first recovery data from a third remote distributed zone and receiving the first recovery data from the third remote distributed zone.

5. The system of claim 1, wherein the combining the first recovery data and the second recovery data comprises performing a bitwise XOR operation of the first recovery data and the second recovery data to obtain the requested data.

6. The system of claim 1, wherein the client request for the requested data corresponds to a data segment in a chunk that stores the requested data.

7. The system of claim 6, wherein the requesting the requested data from the first remote distributed zone comprises identifying the chunk, and an offset value and a size value representing the data segment.

8. The system of claim 6, wherein the chunk is a first chunk, wherein the first recovery data corresponds to a first counterpart data segment in a second chunk, and wherein the second recovery data corresponds to a second counterpart data segment in a third chunk in which the third chunk comprises a bitwise XOR combination of the first chunk and the second chunk.

9. A method, comprising,
receiving, by a system comprising a processor in a first geographically distributed zone, a request from a second geographically distributed zone for requested data owned by the first geographically distributed zone;
determining, by the system in the first geographically distributed zone, that the requested data is not returnable from the first geographically distributed zone; and
in response to the determining, instructing, by the system in the first geographically distributed zone, the second geographic zone to recover the requested data.

10. The method of claim 9, wherein the request is a first request, wherein the requested data is first requested data, and further comprising,
receiving, by the system in the first geographically distributed zone, a second request from a client requester for second requested data owned by the first geographically distributed zone;
determining, by the system in the first geographically distributed zone, that the second requested data is not returnable from the first geographically distributed zone; and
in response to the determining,
instructing, by the system in the first geographically distributed zone, the second geographic zone to provide a first recovery part of the requested data,
instructing, by the system in the first geographically distributed zone, a third geographic zone to provide a second recovery part of the requested data,
receiving, by the system in the first geographically distributed zone, the first recovery part,
receiving, by the system in the first geographically distributed zone, the second recovery part,
recovering, by the system in the first geographically distributed zone, the second requested data by combining the first recovery part and the second recovery part, and
returning, by the system in the first geographically distributed zone, the second requested data to the client requester in response to the second request.

11. The method of claim 9, wherein the recovering the second requested data by combining the first recovery part and the second recovery part comprises performing an XOR operation.

12. The method of claim 9, wherein the requested data is part of a corrupt data storage chunk owned by the first geographically distributed zone, and further comprising, initiating, by the system in the first geographically distributed zone, recovery of a non-corrupt replacement copy of the corrupt data storage chunk.

13. The method of claim 9, wherein the requested data is part of a lost data storage chunk owned by the first geographically distributed zone, and further comprising, initiating, by the system in the first geographically distributed zone, recovery of a replacement copy of the lost data storage chunk.

14. A machine-readable storage medium, comprising executable instructions that, when executed by a processor of a system in a second distributed zone of a data storage system of geographic zones, facilitate performance of operations, the operations comprising:
receiving a client request for requested data owned by a first distributed zone;
in response to the client request, requesting the requested data from the first distributed zone;
receiving an indication from the first distributed zone that the requested data is not returnable from the first distributed zone;
obtaining first recovery data;
obtaining second recovery data from a third distributed zone;
combining the first recovery data and the second recovery data to obtain the requested data; and
returning the requested data from the second distributed zone in response to the client request.

15. The machine-readable storage medium of claim 14, wherein the obtaining the first recovery data comprises accessing a storage device of the second distributed zone.

16. The machine-readable storage medium of claim 14, wherein the obtaining the first recovery data comprises requesting and receiving the first recovery data from a fourth distributed zone.

17. The machine-readable storage medium of claim 14, wherein the combining the first recovery data and the second recovery data comprises performing a bitwise XOR operation of the first recovery data and the second recovery data to obtain the requested data.

18. The machine-readable storage medium of claim 14, wherein the receiving the client request comprises receiving a request for an object that corresponds to a data segment in a data chunk owned by the first distributed zone.

19. The machine-readable storage medium of claim 18, wherein the chunk is a first chunk, wherein the obtaining the first recovery data comprises accessing a first counterpart data segment maintained in a second chunk owned by the second distributed zone, and wherein the obtaining the second recovery data from the third distributed zone comprises requesting a second counterpart data segment maintained in a third chunk owned by the third distributed zone.

20. The machine-readable storage medium of claim 18, wherein the chunk is a first chunk, wherein the obtaining the first recovery data comprises requesting a first counterpart data segment maintained in a second chunk owned by a fourth distributed zone, and wherein the obtaining the second recovery data from the third distributed zone comprises requesting a second counterpart data segment maintained in a third chunk owned by the third distributed zone.
